(19) United States
(12) Patent Application Publication
(10) Pub. No.: US 2007/0079489 A1
(43) Pub. Date: Apr. 12, 2007

(54) Rotational tool alignment adapter arrangement and associated provision method

(75) Inventor: John M. Cirino, Kirtland, OH (US)

Correspondence Address: PEARNE & GORDON LLP, 1801 EAST 9TH STREET, SUITE 1200, CLEVELAND, OH, 44114-3108, US

(73) Assignee: Master Tool Corporation, Grand River, OH (US)

(21) Appl. No.: 11/246,931

(22) Filed: Oct. 7, 2005

(51) Int. Cl. B23P 21/00

(52) U.S. Cl. 29/33 K; 409/233; 409/131

(57) ABSTRACT

A cutting tool assembly includes a spindle having a rotational axis and a component secured to the spindle. A cutting head assembly having a rotational cutting axis is removably affixed to the component. The component is adjustable relative to the spindle for retaining the rotational cutting axis of the cutting head assembly in co-axial alignment with the rotational axis of the spindle. A method provides a quick change cutting tool assembly.

### FIELD OF THE INVENTION

The present invention relates to cutting tools and, in particular, a cutting tool assembly that requires a high degree of alignment among the various parts of the assembly.

### BACKGROUND OF THE INVENTION

There are a wide range of rotatable tools that are used to make various types of cuts in various types of materials. For example, there are numerous tools that are used to cut circular holes. Also, for example, there are many tools that are used to ream holes or to cut threads into holes.

Often, these rotatable tools form assemblies that include a cutting tool that may include various instruments for cutting. The cutting tool is rotated about a main axis of the tool to accomplish the cutting task. Such a main axis can be referred to as a rotational cutting axis. The cutting tool is often connected to a drive spindle, that is in-turn connected to a device for providing a motive force that causes the spindle and cutting tool to rotate. For example, the spindle may be connected directly, or indirectly through gearing means, to an electric motor. Generally, the spindle is a non-removable part of the rotatable tool assembly, while the cutting tool is a removable part.

As can be appreciated, cutting relatively hard material is associated with a great amount of wear on the cutting tool. Alternatively, different cutting operations generally require different cutting tools. Thus, it is often necessary to remove a particular cutting tool and replace it with a different one. To maintain a high degree of precision, however, it is often imperative for the main axis of the cutting tool to be held in exacting alignment with a rotational axis imposed upon the cutting tool. For example, a very high degree of precision is achieved when the main axis of the cutting tool is co-axial with a rotational axis imposed by a driving spindle. In such a situation, the main axis of the cutting tool becomes the rotational axis of the cutting tool.

One well known approach to the alignment of the cutting tool requires that the new cutting tool itself be aligned relative to the spindle through a long and time-consuming process involving a multiplicity of fasteners and alignment measuring tools. For example, the cutting tool may be secured to the spindle through a series of bolts. Additionally, the process may also include various spacers, such as shims. Next, each bolt must be individually tightened or loosened. Finally, the alignment of the cutting tool is checked against the spindle using the alignment measuring tools. This process is repeated in an iterative fashion until the main axis of the new cutting tool is co-axial with rotational axis of the spindle.

This well known approach is time consuming, requires a great deal of knowledge and skill, and must be performed every time the cutting tool is replaced. For example, it may take over an hour to properly align the new cutting tool. Additionally, the user must possess a high degree of mechanical knowledge, skill, and specialized alignment equipment to perform this process. These restrictions are especially problematic and detrimental to users who replace the cutting tool frequently.

### SUMMARY OF THE INVENTION

The following presents a simplified summary of the invention in order to provide a basic understanding of some aspects of the invention. This summary is not an extensive overview of the invention. It is intended to identify neither key nor critical elements of the invention nor delineate the scope of the invention. Its sole purpose is to present some concepts of the invention in a simplified form as a prelude to the more detailed description that is presented later.

In accordance with an aspect, the present invention provides a cutting tool assembly having a rotational cutting axis that includes a spindle. The assembly includes a component secured to the spindle. The assembly also includes a cutting head assembly. The component is adjustable relative to the spindle for retaining the rotational cutting axis of the cutting head in co-axial alignment with the rotational axis of the spindle.

In accordance with another aspect, the present invention provides a method of providing a quick change cutting tool assembly that includes a spindle having a rotational axis, a component, and a cutting head assembly having a rotational axis. The method includes securing the component to the spindle, adjusting the component relative to the spindle such that the rotational axis of the spindle will be co-axial with the rotational axis of the cutting head assembly, and removably affixing the cutting head assembly to the component.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective, exploded view of an example tool assembly that incorporates an aspect of the present invention;

FIG. 2A is a front view of an example alignment component from the tool assembly of FIG. 1;

FIG. 2B is a sectional view along line 2B-2B of an example alignment component from the tool assembly of FIG. 1; and

FIG. 3 is a side sectional view of tool assembly that incorporates an aspect of the present invention.

### DETAILED DESCRIPTION OF AN EXAMPLE EMBODIMENT

An example embodiment of a device that incorporates the present invention is shown in the drawings. It is to be appreciated that the shown example is not intended to be a limitation on the present invention. Specifically, the present invention can be utilized in other embodiments and even other types of devices. Such other types of devices include various types of cutting devices.

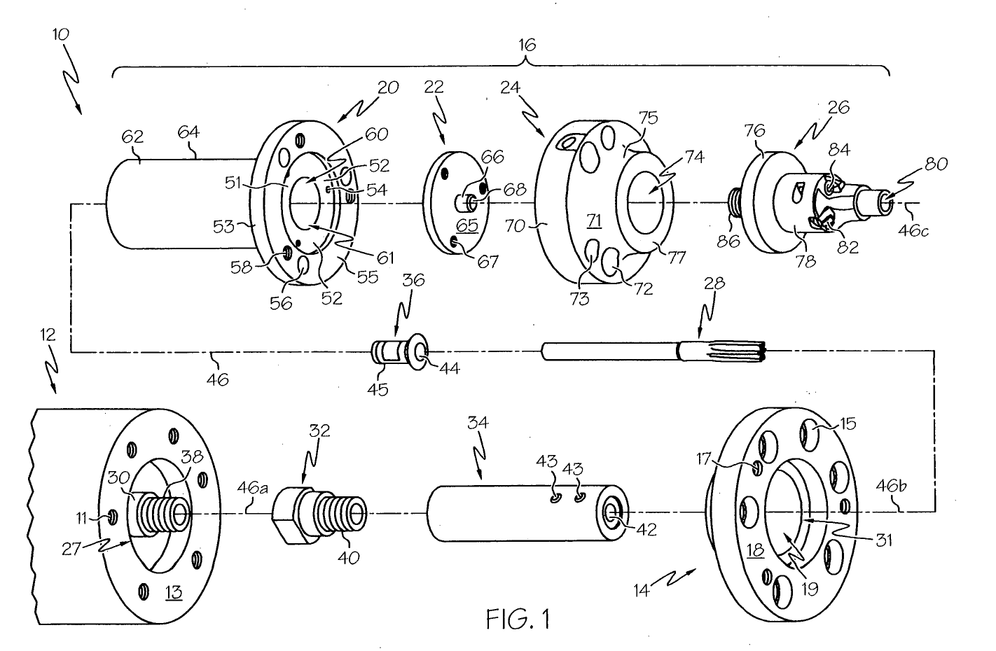

Turning to the shown example of FIG. 1, the device is a rotatable valve seat tool assembly 10 for making (e.g., via cutting) a valve seat (not shown) in an engine head (not shown). Generally, the tool assembly 10 includes a spindle 12, a component 14, and a cutting head assembly 16, and extends along a longitudinal axis 46. The assembly is rotatable about the longitudinal axis 46 via the spindle 12. Of course, the tool assembly 10 may take other forms, such as a tool for making something other than a valve seat, and could even be moved in a motion other than a rotational motion.

Turning back to the shown example, the spindle 12 is secured to a tooling apparatus (not shown) that provides a motive force to rotate the spindle about a rotational axis 46a, which is co-axial with the longitudinal axis 46. The spindle also includes a mounting face 13. In the shown example, the mounting face 13 is circular in shape and forms a plane that is perpendicular to the rotational axis 46a.

At least one hole 11 is disposed about the mounting face 13 for fastening the component 14 to the spindle 12. In the shown example, six holes 11 are disposed evenly about the mounting face 13, and the holes 11 are internally threaded to receive fasteners (not shown). It is to be appreciated that any number of holes 11 may be disposed about the mounting face 13 with any arrangement. Additionally, the holes 11 may include any features for receiving fasteners.

The spindle 12 also includes an opening 27 through the mounting face 13 for receiving the component 14 and the cutting head assembly 16. The opening 27 may be of any depth, and may extend entirely through the spindle 12. The opening 27 may also include a reduced diameter portion (not shown) that creates a shoulder (not shown) adapted to receive a portion of the component 14.

With regard to the spindle 12 of the tool assembly 10, it is to be appreciated that the particulars of the spindle are not limitations on the present invention. As shown, the spindle 12, and the opening 27 therein, are cylindrical in configuration. It is to be appreciated that the spindle 12 and the opening 27 may each be of any desired configuration.

A draw bar 30 is located within the opening 27 and is adapted for axial movement along the longitudinal axis 46. The tooling apparatus (not shown) provides a motive force (e.g., rotational and axial) for movement of the draw bar 30. The draw bar 30 may extend beyond the mounting face 13, or it may recede into the opening 27 such that the draw bar is located wholly within the spindle 12. In the shown example, the central axis of the draw bar 30 is co-axial to the longitudinal axis 46.

Often, the draw bar 30 is itself an element of the tooling apparatus. As such, it is advantageous for the draw bar 30 to include features that enable it to be secured to a variety of additional elements. In the shown example, the draw bar 30 includes threads 38 at one end. It is to be appreciated that the draw bar 30 may include any means for fastening additional elements thereto as required. In the shown example, a draw bar adaptor 32 is adapted at one end to be secured to the draw bar 30 by internal threads (not shown). The draw bar adapter 32 also includes additional fastening means 40 at the opposite end that enable it to be secured to a variety of additional elements. In the shown example, the fastening means 40 comprises external threads. It is to be appreciated that the draw bar adapter 32 may include any means for fastening additional elements thereto as required.

In the shown example, a reamer chuck 34 is adapted to be fastened to the draw bar adapter 32. The reamer chuck 34 includes internal threads (not shown) at one end that engage with the external threads 40 of the draw bar adapter 32. It is to be appreciated that the reamer chuck 34 may include any fastening means as required by the draw bar adapter 32. The reamer chuck 34 also includes a hole 42 at the opposite end adapted to receive a reamer chuck collet 36.

The reamer chuck 34 further includes means 43 for retaining the reamer chuck collet 36 within the hole. In the shown example, the retaining means 43 comprises set screws. It is to be appreciated that the retaining means 43 may include any other fastening method capable of removably securing the reamer chuck collet 36 within the reamer chuck 34.

The reamer chuck collet 36 includes an extended portion 45 that is adapted to be received by the reamer chuck hole 42. In the shown example, the reamer chuck hole 42 comprises a cylindrical hole extending into the reamer chuck 34, and the extended portion 45 comprises a cylindrical configuration adapted to be received by the hole 42. It is to be appreciated that the reamer chuck hole 42 and the extended portion 45 may be of any configuration such that each is compatible with the other. The reamer chuck collet 36 further includes a hole 44 that is adapted to receive a reamer 28. In the shown example, the collet hole 44 comprises a hole extending through the collet 36. It is to be appreciated that the hole 44 is not required to extend through the collet 36, and may be of any configuration as required to engage with any particular reamer 28.

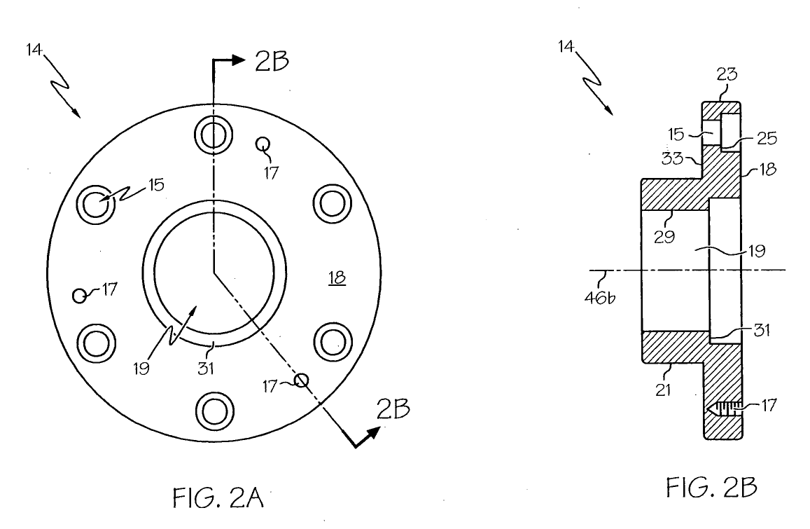

Turning now to FIGS. 2A and 2B, the component 14 has a generally cylindrical configuration having a rotational axis 46b and includes an enlarged annular shoulder 23 disposed at one end. In the shown example, the rotational axis 46b is co-axial with the central axis of the component 14. A first mounting face 18 is disposed on one side of the annular shoulder 23, and a second mounting face 33 is disposed on the opposite side of the shoulder 23. A reduced diameter region 21 is disposed adjacent to the shoulder 23 and the second mounting face 33. The reduced diameter region 21 may be adapted to be received in the reduced diameter portion (not shown) of the opening 27 in the spindle 12. A hole 19 extends from the first mounting face 18 through the component 14. The hole 19 includes a reduced diameter portion 29 that creates a shoulder 31. In the shown example, the central axes of the hole 19 and the reduced diameter portion 29 are co-axial with the rotational axis 46b of the component 14.

The annular shoulder 23 also includes at least one of a first hole 15 extending there through from the first mounting face 18 to the second mounting face 33. In the shown example, the first hole 15 is located near the outer edge of the annular shoulder 23. It is to be appreciated that the first hole 15 may be of any geometry and may be located anywhere on the first mounting face 18. In the shown example, six holes 15 are disposed evenly about the first mounting face 18 of the annular shoulder 23. It is to be appreciated that any number of holes 15 may be disposed about the first mounting face 18 with any arrangement.

In the shown example, the first hole 15 is counterbored, such that the inner diameter of the first hole 15 is greater on the side near the first mounting face 18 and smaller on the side near the second mounting face 33. The counterbore creates a shoulder 25 disposed within the first hole 15 that is adapted to abut a fastener portion, such as a bolt head or socket head cap screw head. It is to be appreciated that the first hole 15 is not required to be counterbored and may have a constant diameter along its entire length. Additionally, the first hole 15 may include other features for fastening, such as countersinking and/or threading.

The annular shoulder 23 also includes at least one of a second hole 17 extending from the first mounting face 18. In the shown example, the second hole 17 is a blind hole and is located near the outer edge of the annular shoulder 23. It is to be appreciated that the second hole 17 may be of any geometry and may be located anywhere on the first mounting face 18. In the shown example, three second holes 17 comprising blind holes are disposed evenly about the first mounting face 18 of the annular shoulder 23. It is to be appreciated that any number of holes 17 may be disposed about the first mounting face 18 in any arrangement.

In the shown example, the second hole 17 is an internally threaded blind hole. It is to be appreciated that the second hole 17 is not required to be internally threaded, and it may extend entirely through the annular shoulder 23. Additionally, the second hole 17 may include other features for fastening, such as counterboring or the like.

Turning back to the shown example in FIG. 1, the cutting head assembly 16 has a rotational cutting axis 46c. In the shown example, the rotational cutting axis 46c is co-axial with the longitudinal axis 46 and thus the rotational axis 46a of the spindle 12. Such co-axial alignment is one aspect of the present invention as is discussed further below. The cutting head assembly 16 includes an adapter backplate 20, a reamer guide plate 22, a cutting head adapter 24, and a cutting head 26. It is to be appreciated that the cutting head assembly 16 is not meant to be limited by this description, and may include more or less elements. In the shown example, these four elements are secured together as one assembly 16 before being secured to the component 14 and spindle 12. Generally, the reamer guide plate 22 is first attached to the adapter backplate 20. Next, cutting head adapter 24 is attached to the adapter backplate 20. Finally, the cutting head 26 is attached to the cutting head adapter 24. However, it is to be appreciated that these elements may be secured together in any order or combination, and may or may not be secured to the component 14 and/or spindle 12 as one assembly. For example, the cutting head 26 may be removed and replaced without the need to also remove or replace any other elements of the cutting head assembly 16 from the component 14 and/or spindle 12.

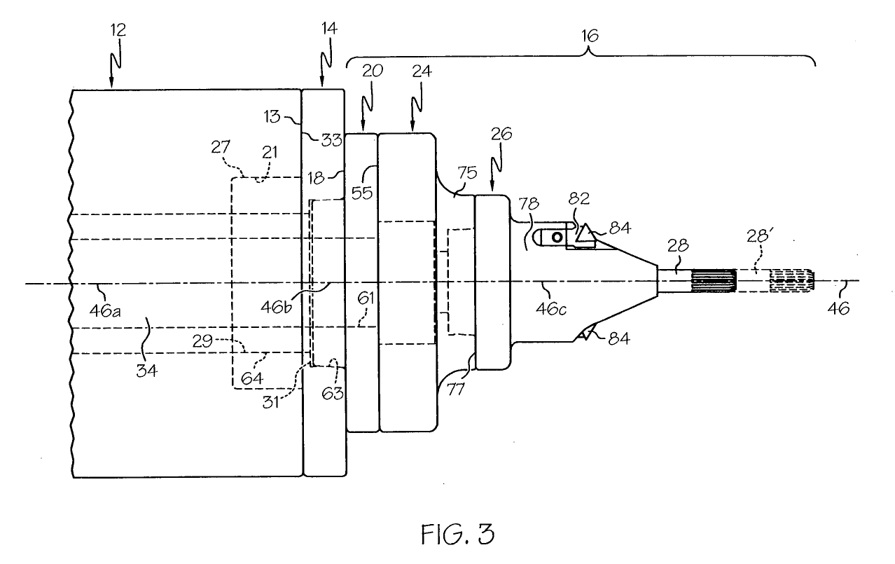

The adapter backplate 20 has a generally cylindrical configuration and includes an enlarged first annular shoulder 53 disposed at one end. A mounting face 55 is disposed on one side of the first annular shoulder 53. Turning briefly to FIG. 3, the adapter backplate 20 includes a second annular shoulder 63 disposed on the opposite side of the shoulder 53 from the mounting face 55. In the shown example, the diameter of the second annular shoulder 63 is less than the diameter of the first annular shoulder 53. It is to be appreciated that the diameter of the second annular shoulder 63 may also be equal to or greater than that of the first annular shoulder 53. Turning back to FIG. 1, an extended portion 62 forms a reduced diameter region 64 disposed on the opposite side of the shoulder 53 from the mounting face 55. The reduced diameter region 64 may be adapted to be received in the reduced diameter portion 29 of the hole 19 in the component 14.

The first annular shoulder 53 of the adapter backplate 20 also includes at least one of a first hole 56 extending from the mounting face 55 through the first shoulder 53. In the shown example, the first hole 56 is located near the outer edge of the first annular shoulder 53. It is to be appreciated that the first hole 56 may be of any geometry and may be located anywhere on the first mounting face 55. In the shown example, three holes 56 are disposed evenly about the mounting face 55 of the first annular shoulder 53. It is to be appreciated that any number of holes 56 may be disposed about the mounting face 55 in any arrangement. It is to be appreciated that the first hole 56 may include any features for fastening, such as counterboring or the like, and/or threading.

The first annular shoulder 53 also includes at least one of a second hole 58 extending from the mounting face 55. In the shown example, the second hole 58 comprises a blind hole and is located near the outer edge of the first annular shoulder 53. It is to be appreciated that the second hole 58 may be of any geometry and may be located anywhere on the first mounting face 55. In the shown example, three holes 58 comprising blind holes are disposed evenly about the first mounting face 55 of the first annular shoulder 53. It is to be appreciated that any number of holes 58 may be disposed about the first mounting face 55 in any arrangement.

In the shown example, the second hole 58 is an internally threaded blind hole. It is to be appreciated that the second hole 58 is not required to be internally threaded, and it may extend entirely through the annular shoulder 53. Additionally, the second hole 58 may include other features for fastening, such as counterboring or the like.

The adapter backplate 20 further includes a hole 60 that extends from the mounting face 55 there through. In the shown example, the central axes of the adapter backplate 20 and the hole 60 are co-axial with the rotational cutting axis 46c of the cutting head assembly 16. The hole 60 includes a reduced diameter portion 61 adapted to receive the reamer chuck 34. In the shown example, the reduced diameter portion 61 comprises a cylindrical hole. However, it is to be appreciated that the reduced diameter portion 61 may be of any configuration adapted to receive any element that is connected to the draw bar 30.

The reduced diameter portion 61 creates a shoulder 51 that includes a mounting face 52. The mounting face 52 also includes at least one of a hole 54 extending from the mounting face 52. In the shown example, the hole 54 comprises a blind hole and is located near the outer edge of the mounting face 52. It is to be appreciated that the hole 54 may be of any geometry and may be located anywhere on the mounting face 52. In the shown example, three holes 54 comprising blind holes are disposed evenly about the mounting face 52. It is to be appreciated that any number of holes 54 may be disposed about the mounting face 52 in any arrangement.

In the shown example, the hole 54 is an internally threaded blind hole. It is to be appreciated that the hole 54 is not required to be internally threaded, and it may extend entirely through the shoulder 51. Additionally, the hole 54 may include other features for fastening, such as counterboring or the like.

Turning now to the reamer guideplate 22, the guideplate 22 includes a first face 65 on one side and a second face (not shown) on the opposite side. In the shown example, the reamer guideplate 22 has a cylindrical configuration such that the reamer guideplate 22 can be located within the hole 60 of the adapter backplate 20. It is to be appreciated that the guideplate 22 may be of any suitable configuration adapted to permit the guideplate 22 to be located within the hole 60 in the adapter backplate 20. It is also to be appreciated that the guideplate 22 may extend a distance away from the hole 60.

The first face 65 of the reamer guideplate 22 includes at least one of a hole 67 extending from the first face 65 through the reamer guideplate 22. In the shown example, the hole 67 comprises a hole and is located near the outer edge of the first face 65. It is to be appreciated that the hole 67 may be of any geometry and may be located anywhere on the first face 65. In the shown example, three holes 67 are disposed evenly about the first face 65. It is to be appreciated that any number of holes 67 may be disposed about the first face 65 in any arrangement.

In the shown example, the hole 67 is an internally threaded hole extending through the reamer guideplate 22. It is to be appreciated that the hole 67 is not required to be internally threaded. Additionally, the hole 67 may include other features for fastening, such as counterboring or the like.

The reamer guideplate 22 further includes an extended portion 66 that extends away from the first face 65. In the shown example, the extended portion 66 has a cylindrical configuration with a diameter less than that of the guideplate 22. It is to be appreciated that the extended portion 66 may be of any size or configuration. The guideplate 22 further includes a hole 68 that extends from the extended portion 66 through the guideplate 22. The reamer guideplate 22 acts to retain the rotational axis of the reamer 28 in co-axial alignment with the rotational axis of the reamer guideplate 22. The diameter of the hole 68 must be slightly greater than the diameter of the reamer 28, such that the reamer is able to translate freely along the longitudinal axis 46 of the tool assembly 10. However, the diameter of the hole 68 must not be so great such that the reamer guideplate 22 is not effective to maintain the co-axial alignment.

Turning now to the cutting head adapter 24, the adapter 24 includes an enlarged annular shoulder 70 disposed at one end. The annular shoulder 70 includes a first face 71 on one side and a second face (not shown) on the opposite side. It is to be appreciated that the adapter 24 may be of any desired configuration.

The annular shoulder 70 also includes at least one of a first hole 72 and at least one of a second hole 73 extending from the first face 71 through the shoulder 70. In the shown example, the holes 72 and 73 comprise holes and are located near the outer edge of the annular shoulder 70. It is to be appreciated that the holes 72-73 may be of any geometry and may be located anywhere on the first face 71. In the shown example, three first holes 72 (the third not shown) and three second holes 73 (the third not shown) comprise holes that are disposed evenly about the first face 71 of the shoulder 70. It is to be appreciated that any number of holes 72-73 may be disposed about the first face 71 in any arrangement.

In the shown example, the holes 72-73 are counterbored, such that the inner diameters of the holes 72-73 are greater on the side near the first face 71 and are smaller on the side near the second face (not shown). The counterbore creates a shoulder (not shown) disposed within the holes 72-73 that is adapted to abut a fastener, such as the head of a bolt or socket head cap screw. It is to be appreciated that neither hole 72-72 is required to be counterbored and either, or both, may have a constant diameter along their entire length. Additionally, either, or both, holes 72-73 may include other features for fastening, such as countersinking and/or threading. In the shown example, the diameter of the first hole 72 appears greater than the diameter of the second hole 73. It is to be appreciated that the diameter of either hole 72-73 may be greater than or less than the other.

The cutting head adapter further includes an extended portion 75 extending away from the shoulder 70. A mounting face 77 is disposed at a distal end of the extended portion 75. In the shown example, the extended portion 75 has a cylindrical configuration with a diameter less than that of shoulder 70. It is to be appreciated that the extended portion 75 may be of any diameter or configuration. The cutting head adapter 24 further includes a hole 74 that extends from the mounting face 77 through the adapter 24. It is to be appreciated that the hole 74 may be of any configuration, and may include a constant or varied diameter as it extends through the cutting adapter 24. In the shown example, the central axes of the cutting head adapter 24 and the hole 74 are co-axial with the rotational cutting axis 46c of the cutting head assembly 16.

Turning now to the cutting head 26, the cutting head includes an enlarged annular shoulder 76 disposed at one end. The cutting head 26 also includes a first extended portion 78 extending away from the shoulder 76 and a second extended portion 86 that extends away in the opposite direction. The second extended portion 86 is adapted to engage with the cutting head adapter 24 for securing the cutting head 26 to the cutting head adapter 24. It is to be appreciated that the cutting head adapter 24 may contain additional elements for engaging with the second extended portion 86. In the shown example, the extended portions 78 and 86 have generally cylindrical configurations. It is to be appreciated that the cutting head 26, shoulder 76 and extended portions 78 and 86 may be of any configuration.

The first extended portion 78 includes a hole 80 that is disposed at one end extends through the cutting head 26. In the shown example, the central axes of the cutting head 26 and the hole 80 are co-axial with the rotational cutting axis 46c of the cutting head assembly 16. The hole 80 is adapted to permit the reamer 28 to extend a distance from the cutting head 26 for cutting. The reamer 28 may translate through the hole 80 along the longitudinal axis 46c of the cutting head 26 to various distances as required. Turning briefly to FIG. 3, the reamer 28 is shown in an example extended position 28′ (via the phantom lines). The translation of the reamer 28 is independent from the relative motion of the tool assembly 10, and may be performed while the tool assembly 10 is rotating, stationary, or making any other movement. Additionally, the reamer 28 may be withdrawn such that it is located wholly within the cutting head. The diameter of the hole 80 must be slightly greater than the diameter of the reamer 28, such that the reamer is able to translate freely along the longitudinal axis 46c of the cutting head 26. However, the diameter of the hole 80 must not be so great such that the co-axial alignment cannot be maintained.

The extended portion 78 further includes at least one cutting means 82 adapted to perform a cutting operation that is separate from that of the reamer 28. In the shown example, three cutting means 82 (the third not shown) are arranged about a periphery of the extended portion 78. The cutting means 82 are secured to the cutting head 26 by fasteners (not shown). It is to be appreciated that any number of cutting means 82 may be secured to the cutting head 26 using any known method of fastening. It is also to be appreciated that the cutting head 26 is not required to include any cutting means 82.

Turning briefly to FIG. 3, the cutting means 82 may include a cutting insert 84. In the shown example, the cutting insert 84 is triangular in shape and is exposed from the cutting head 26 for cutting. The cutting insert 84 has at least one sharpened cutting edge that is adapted to extend radially outward from the cutting means 82 and the cutting head 26 at a desired cutting angle. Thus, for example, upon rotation of the tool assembly 10, the cutting insert 84 engages material (e.g., the engine head) to be cut and removes portions of the material (e.g., to cut a valve seat). It is to be appreciated that the cutting insert 84 is made of a material that is sufficiently durable (e.g., metal) such that an effective (e.g., sharp) cutting edge can be readily obtained and retained for a relatively long duration.

In the shown example, the insert 84 may have multiple cutting edges, each of which can be selectively positioned for cutting. In the shown example, the insert 84 is triangular and has three cutting edges. Due to the triangular configuration of the insert 84, one selected cutting edge is positioned to perform the valve seat cutting. Once that cutting edge is worn, the insert 84 is merely rotated (e.g., 120° ) to present a new sharpened edge for the cutting operation.

The cutting head 26 is capable of performing at least two separate cutting operations simultaneously when equipped with both cutting means 82 and a reamer 28. Because the cutting means 82 are arranged about a periphery of the cutting head 26 and extend radially outward at a desired angle, and the reamer 28 extends from the cutting head 26 along the longitudinal axis 46c, each will engage the material (e.g., the engine head) at a different location. For example, the cutting means 82 may cut a valve seat in an engine head, while the reamer 28 may ream the associated shaft that extends through the engine head for a poppet valve. It is to be appreciated that these cutting operations may be performed simultaneously, or may each be performed independent of the other.

Turning back to FIG. 1, the tool assembly 10 is generally assembled in the order shown, beginning with the spindle 12 and ending with the cutting head 26. It is to be appreciated that the tool assembly 10 may be assembled in any order, and may include a fewer or a greater number of elements. First, the draw bar adapter 32 is attached to the draw bar 30. Next, the reamer chuck 34 is attached to the draw bar adapter 32. Next, the reamer 28 is located within the reamer chuck collet 36, and that associated sub-assembly is secured within the hole 42 of the reamer chuck 34 using the retaining means 43.

Next, the component 14 is secured to the spindle 12 by fasteners (not shown). In the shown example, the rotational axis and the central axis of the component 14 are co-axial. Turning briefly to FIG. 3, the second mounting face 33 of the component abuts the mounting face 13 of the spindle 12 such that the reduced diameter region 21 of the component is received in the opening 27 in the spindle. Turning back to the shown example of FIG. 1, six fasteners (e.g., bolts or socket head cap screws, not shown) are located within the holes 15 of the component 14 and engage the six threaded holes 11 disposed about the face 13 of the spindle12. The fasteners are tightened to secure the component 14 to the spindle 12. Additionally, the process may also include various spacers, such as shims.

Next, the central axis 46b of the component 14 must be made to be co-axial with the longitudinal axis 46 of the tool assembly 10, and thus co-axial with the rotational axis 46a of the spindle 12. To achieve this, each fastener (not shown) must be individually tightened or loosened, while the alignment of the component 14 is checked relative to the spindle using alignment measuring tools. This process is repeated in an iterative fashion until the central axis 46b of the component 14 is co-axial with the rotational axis 46a of the spindle 12. In the shown example, this time-consuming procedure of securing and aligning the component 14 to the spindle 12 is to be performed only once while assembling the cutting tool assembly 10. It is to be appreciated that this process may be performed as many times as required. Additionally, the alignment of the component to the spindle may be checked periodically, and the appropriate adjustments made to ensure the central axis 46b of the component 14 remains co-axial to the rotational axis 46a of the spindle 12.

Next, the cutting head assembly 16, or any sub-assembly or element thereof, may be secured to the component 14. Turning briefly to FIG. 3, the mounting face 18 of the component abuts the second mounting face (not shown) of the adapter backplate 20 such that the second annular shoulder 63 of the adapter backplate 20 abuts the shoulder 31 of the component 14. Additionally, the reduced diameter portion 64 of the adapter backplate 20 is received in the reduced diameter portion 29 of the component 14, and further extends into the hole 27 of the spindle 12. Turning back to the shown example of FIG. 1, three fasteners (e.g., bolts or socket head cap screws, not shown) are located within the holes 72 and 56 of the cutting head adapter 24 and the adapter backplate 20, respectively. The fasteners engage the three threaded holes 17 disposed about the face 18 of the component 14 to secure the cutting head assembly 16 thereto. In the shown example, the reamer 28 is now located within the holes 60, 68, 74, 80 of the adapter backplate 20, reamer guideplate 22, cutting head adapter 24, and cutting head 26, respectively.

No further alignment of the cutting head assembly 16 is required once it is secured to the component 14. Because the central axis 46b of the component 14 is co-axial with the longitudinal axis 46 of the tool assembly 10, and thus co-axial with the rotational axis 46a of the spindle 12, the rotational cutting axis 46c of the cutting head assembly 16 is automatically retained in co-axial alignment with the rotational axis 46a of the spindle 12. As such, the cutting head assembly 16, or any sub-assembly or element thereof, may be removed and replaced at will without the need for any further alignment procedures. For example, the cutting head 26 may be quickly removed and replaced from the tool assembly 10, and upon its reattachment to the cutting head adapter 24, the rotational cutting axis 46c of the cutting head 26 will be automatically retained in co-axial alignment with the rotational axis 46a of the spindle 12. Therefore, in the shown example, the rotational cutting axis of the reamer 28 and the cutting means 82 will be retained in co-axial alignment with the rotational axis 46a of the spindle 12 any time the cutting head assembly 16, or any sub-assembly or element thereof, is removed and replaced.

It is to be appreciated that the present invention includes a method of providing a quick change cutting tool assembly. In one example, the present invention thus provides a method of providing a quick change cutting tool assembly that includes a spindle having a rotational axis, a component and a cutting head assembly having a rotational cutting axis. The method includes securing the component to the spindle, adjusting the component relative to the spindle such that the rotational axis of the spindle will be co-axial with the rotational cutting axis of the cutting head assembly, and removably affixing the cutting head assembly to the component.

The invention has been described with reference to the preferred embodiments. Obviously, modifications and alterations will occur to others upon a reading and understanding of this specification. It is intended to include all such modifications and alterations insofar as they come within the scope of the appended claims or the equivalents thereof.

1. A cutting tool assembly, including:
a spindle having a rotational axis;
a component secured to the spindle; and
a cutting head assembly having a rotational cutting axis and removably affixed to the component, wherein the component is adjustable relative to the spindle for retaining the rotational cutting axis of the cutting head assembly in co-axial alignment with the rotational axis of the spindle.

2. The cutting tool assembly as set forth in claim 1, wherein the rotational cutting axis, of the cutting head assembly will be retained in co-axial alignment with the rotational axis of the spindle upon removal and replacement of the cutting head assembly without further adjustment of the component.

3. The cutting tool assembly as set forth in claim 1, wherein the component includes at least one hole for securing the component to the spindle by at least one fastening means.

4. The cutting tool assembly as set forth in claim 3, wherein the fastening means includes bolts.

5. The cutting tool assembly as set forth in claim 1, wherein the assembly is rotatable.

6. The cutting tool assembly as set forth in claim 1, wherein the cutting head assembly includes a cutting head.

7. The cutting tool assembly as set forth in claim 6, wherein the cutting head includes cutting means.

8. The cutting tool assembly as set forth in claim 7, wherein the cutting means includes at least one cutting insert that is metal-based.

9. The cutting tool assembly as set forth in claim 1, wherein the cutting head assembly further includes a hole and a cutting tool insert located within the hole, the cutting tool insert being capable of extending from the cutting head assembly for cutting.

10. The cutting tool assembly as set forth in claim 9, wherein the spindle further includes a draw bar engaged with the cutting tool insert for extending the cutting tool insert from the cutting head assembly for cutting.

11. The cutting tool assembly as set forth in claim 1, wherein the cutting head assembly is capable of performing at least two separate cutting operations simultaneously.

12. A method of providing a quick change cutting tool assembly that includes a spindle having a rotational axis, a component and a cutting head assembly having a rotational cutting axis, the method including:
securing the component to the spindle;
adjusting the component relative to the spindle such that the rotational axis of the spindle will be co-axial with the rotational axis cutting of the cutting head assembly; and
removably affixing the cutting head assembly to the component.

13. The method as set forth in claim 12, further including:
removing the cutting head assembly; and
replacing the cutting head assembly, wherein the rotational cutting axis of the cutting head assembly will be retained in co-axial alignment with the rotational axis of the spindle without further adjustment of the component.

14. The method as set forth in claim 12, wherein the method includes providing the component with at least one hole for securing the component to the spindle by at least one fastening means.

15. The method as set forth in claim 14, wherein the fastening means includes bolts.

16. The method as set forth in claim 12, wherein the method includes providing the assembly as a rotatable assembly.

17. The method as set forth in claim 12, wherein the method includes providing the cutting head assembly with a cutting head.

18. The method as set forth in claim 17, wherein the method includes providing the cutting head with cutting means.

19. The method as set forth in claim 18, wherein the cutting means includes at least one cutting insert that is metal-based.

20. The method as set forth in claim 12, wherein the cutting head assembly further includes a hole and a cutting tool insert located within the hole, and the method includes extending the cutting tool insert from the cutting head assembly for cutting.

21. The method as set forth in claim 20, wherein the spindle further includes a draw bar, and the method includes engaging the cutting tool insert with the draw bar and moving the draw bar to extend the cutting tool insert from the cutting head assembly for cutting.

22. The method as set forth in claim 12, wherein the method includes performing at least two separate cutting operations simultaneously with the cutting head assembly.
